(19) United States
(12) Patent Application Publication
(10) Pub. No.: US 2006/0281830 A1
(43) Pub. Date: Dec. 14, 2006

(54) Ink composition and writing instrument

(75) Inventor: Zenshiro Iijima, Soka-shi (JP)

Correspondence Address: BACON & THOMAS, PLLC, 625 SLATERS LANE, FOURTH FLOOR, ALEXANDRIA, VA, 22314, US

(73) Assignee: ADGER KOGYO CO., LTD., Soka-shi (JP)

(21) Appl. No.: 11/438,302

(22) Filed: May 23, 2006

(30) Foreign Application Priority Data
Jun. 8, 2005 (JP) 2005-168451

(51) Int. Cl. C03C 17/00

(52) U.S. Cl. 523/160; 524/287

(57) ABSTRACT

An ink composition giving erasable white ink patterns and containing water and sodium benzoate dissolved in the water in an amount of at least 5 parts by weight per 100 parts by weight of the water. A writing instrument having a pen tip and an ink tank which contains the above ink composition and which is in fluid communication with the pen tip.

### CROSS-REFERENCE TO RELATED APPLICATION

This application claims, under 35 USC 119, priority of Japanese Patent Application No. 2005-168451, filed Jun. 8, 2005, disclosure of which, inclusive of the specification and claim, is hereby incorporated by reference herein.

### BACKGROUND OF THE INVENTION

1. Field of the Invention

This invention relates to an ink composition giving white ink images which are erasable by wiping with a wet cloth impregnated with water. The present invention is also concerned with a writing instrument utilizing the above ink.

2. Description of Prior Art

Various erasable inks are known and are utilized in the field of, for example, sewing or arts and crafts (U.S. Pat. Nos. 4,368,076, 4,441,928 and 4,509,982). The known erasable inks now on the market, however, are predominantly of a type which gives colored ink images and, therefore, are not suited for writing on a dark-colored surface. Known white colored inks generally contain a white pigment or dye, such as titanium white, and are not easily erasable.

U.S. Pat. No. 4,744,826 discloses an aqueous transparent ink composition affording erasable, white ink images. This composition contains an amine complex salt of zinc and has a problem because odor of ammonia emanates upon use. U.S. Pat. No. 4,840,833 discloses an ink composition containing a fine powder of white colored water soluble alkali salt of aliphatic sulfate dispersed in a monohydric alcohol. The ink is suited for preparing a pressure sensitive reproducing material. When used with a felt tip pen, however, the ink is apt to cause clogging. U.S. Pat. No. 5,082,495 discloses an ink composition giving erasable, white ink images. This composition contains an organic solvent, salicyclic acid or acetylsalicyclic acid dissolved in the organic solvent and a polymer which is dissolved in the organic solvent and which has a molecular weight of at least 10,000. Because salicyclic acid and acetylsalicyclic acid are sublimable substances, the white images are spontaneously erased with time. Thus, the ink images cannot be kept unerased for a necessary period of time.

### SUMMARY OF THE INVENTION

It is an object of the present invention to provide an ink composition capable of giving white letters or patterns which do not spontaneously disappear but are easily erasable when necessary with water.

It is another object of the present invention to provide a writing instrument such as a felt-tip pen or a fiber-tip pen giving a white image on a black or dark paper, cloth or any other ink receiving material.

In accordance with one aspect of the present invention there is provided an ink composition comprising water and sodium benzoate dissolved in the water in an amount of at least 5 parts by weight per 100 parts by weight of the water.

In another aspect the present invention provides a writing instrument having a pen tip and an ink tank which contains the above ink composition and which is in fluid communication with the pen tip.

The ink composition of the present invention is substantially colorless and transparent. When applied on a fabric, paper, leather, metal, wood, plastic or the like ink receiving surface, however, the written image turns white as the water evaporates. The resulting white ink image does not spontaneously disappear but may be easily removed by, for example, wiping with a wet cloth or a sponge impregnated with water, when necessary.

Other objects, features and advantages of the present invention will become apparent from the detailed description of the preferred embodiments of the invention which follows.

### DETAILED DESCRIPTION OF THE PREFERRED EMBODIMENTS OF THE INVENTION

The ink composition of the present invention should contain water and sodium benzoate dissolved in the water in an amount of at least 5 parts by weight per 100 parts by weight of the water. An amount of the sodium benzoate below 5 parts by weight is insufficient to obtain a clear ink image on an ink applied surface. The amount of the sodium benzoate is preferably at least 15 parts by weight, more preferably at least 30 parts by weight, per 100 parts by weight of the water. The upper limit concentration is the solubility of sodium benzoate. Since a saturated solution is apt to form solids as a result of the evaporation of water or cooling of the ink composition, it is desired that the upper limit be slightly below the saturation concentration, preferably 95% of the saturation concentration.

The period of time required for the applied ink image to develop a white image depends upon the concentration of sodium benzoate in the ink composition and upon the environment such as a temperature in which the ink receiving surface is placed. Since it is generally desired to shorten such a developing time, it is desirable that the ink composition contain a volatile water-soluble organic solvent such as an alcohol or a ketone. For reasons of safety, ethanol is preferable as the organic solvent. The amount of the water-soluble organic solvent is generally not more than 100 parts by weight, preferably 5 to 80 parts by weight, per 100 parts by weight of the water contained in the ink composition.

The ink composition preferably additionally contains one or more water-soluble polymeric substances capable of reducing the penetrability of the ink composition into paper, cloth or fabric on which patterns or letters of the ink composition is to be formed. Illustrative of suitable polymeric substances are poly(alkylene oxide) such as poly(ethylene oxide), polyvinyl alcohol, sodium poly(acrylic acid), methyl cellulose and carboxymethyl cellulose. Such a polymeric substance may also serve to prevent the occurrence of blurs of the ink images, to prevent the drying of the ink charged in a writing instrument and to improve the shelf life of the writing instrument. The amount of polymeric substance used varies with the kind thereof but is generally 0.001 to 18 parts by weight, preferably 0.01 to 12 parts by weight, per 100 parts by weight of the water contained in the ink composition.

A water-soluble inorganic material, such as potassium nitrate or sodium nitrate, may be incorporated into the ink composition for the purpose of increasing the density of a white ink image. Such an inorganic material is used in an amount of generally 0.1 to 25 parts by weight, preferably 0.5 to 18 parts by weight, per 100 parts by weight of the water contained in the ink composition. Sodium nitrate is hygroscopic and may contribute to the prevention of the drying of the ink contained in a writing instrument.

The ink composition according to the present invention is suitably used for a writing instrument having a porous or fibrous tip, such as a felt-tip pen. The ink is contained in an ink tank which is in fluid communication with the tip of the writing instrument. The ink composition is particularly suitably used for an chalk pen used in the field of sewing, embroidery, handicraft, etc. The ink composition may also be utilized as a printing ink by suitably controlling the viscosity thereof.

The following examples will further illustrate the present invention. Parts are by weight.

### EXAMPLE 1

Sodium benzoate (55 parts) was dissolved in 100 parts of water. In the resulting aqueous solution, 0.5 part of poly(ethylene oxide) having a molecular weight of 600,000 to 1,100,000 was dissolved to obtain an ink composition. This composition was charged in an ink tank of a felt-tip pen. A pattern was drawn on a black fabric with the pen. A clear, white image was formed on the fabric as the water evaporated. This image was able to be erased by wiping with a water-impregnated wet cloth. Similarly, a white ink pattern was formed on a black fabric. The fabric was then allowed to stand in a room for 15 days, whereupon it was found that the white pattern did not disappear.

### EXAMPLE 2

Sodium benzoate (59 parts) was dissolved in 150 parts of a mixed solvent composed of 100 parts of water and 50 parts of ethanol. In the resulting aqueous solution, 1 part of poly(ethylene oxide) was dissolved to obtain an ink composition. This composition was charged in an ink tank of a felt-tip pen. A pattern was drawn on a black fabric with the pen. A clear, white image was formed on the fabric as the water evaporated. Because of the presence of ethanol, the formation of the white image was facilitated. This image was able to be erased by wiping with a water-impregnated wet cloth. Similarly, a white ink pattern was formed on a black fabric. The fabric was then allowed to stand in a room for 15 days, whereupon it was found that the white pattern did not disappear.

### EXAMPLE 3

An ink composition having the following formulation was prepared:

| | |
|---|---|
| Water | 100 parts |
| Ethanol | 50 parts |
| Sodium benzoate | 40 parts |
| Poly(ethylene oxide) | 1.2 parts |

### EXAMPLE 4

An ink composition having the following formulation was prepared:

| | | |
|---|---|---|
| Water | 100 | parts |
| Ethanol | 30 | parts |
| Sodium benzoate | 55 | parts |
| Poly(ethylene oxide) | 0.5 | part |

### EXAMPLE 5

An ink composition having the following formulation was prepared:

| | | |
|---|---|---|
| Water | 100 | parts |
| Ethanol | 50 | parts |
| Sodium benzoate | 40 | parts |
| Sodium nitrate | 5 | parts |
| Poly(ethylene oxide) | 1 | part |

### EXAMPLE 6

An ink composition having the following formulation was prepared:

| | | |
|---|---|---|
| Water | 100 | parts |
| Ethanol | 50 | parts |
| Sodium benzoate | 45 | parts |
| Carboxymethyl cellulose | 0.5 | part |
| Poly(ethylene oxide) | 1 | parts |

### EXAMPLE 7

An ink composition having the following formulation was prepared:

| | | |
|---|---|---|
| Water | 100 | parts |
| Ethanol | 50 | parts |
| Sodium benzoate | 30 | parts |
| Carboxymethyl cellulose | 1 | part |
| Poly(ethylene oxide) | 1 | part |

### EXAMPLE 8

An ink composition having the following formulation was prepared:

| | | |
|---|---|---|
| Water | 100 | parts |
| Sodium benzoate | 55 | parts |
| Poly(ethylene oxide) | 1 | part |

Each of the ink compositions of Examples 3 to 8 was charged in an ink tank of a felt-tip pen in the same manner as described in Example 1. A pattern was drawn on a black fabric with each pen. A clear, white image was formed on the fabric as the water evaporated. When the fabric was allowed to stand in a room for 15 days, the white pattern did not disappear. Each image was able to be erased by wiping with a water-impregnated wet cloth. The poly(ethylene oxide) used in Examples 2 to 8 had a molecular weight similar to that used in Example 1.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all the changes which come within the meaning and range of equivalency of the claims are therefore intended to be embraced therein.

What is claimed is:

1. An ink composition comprising water and sodium benzoate dissolved in the water in an amount of at least 5 parts by weight per 100 parts by weight of the water.

2. An ink composition as set forth in claim 1, wherein the sodium benzoate is present in an amount of at least 15 parts by weight per 100 parts by weight of the water.

3. An ink composition as set forth in claim 1, wherein the sodium benzoate is present in an amount of at least 30 parts by weight per 100 parts by weight of the water.

4. An ink composition as set forth in claim 1, further comprising a water soluble polymeric substance dissolved in the water.

5. An ink composition as set forth in claim 4, wherein the water soluble polymeric substance is present in an amount of 0.001 to 18 parts by weight per 100 parts by weight of the water.

6. An ink composition as set forth in claim 5, wherein the water soluble polymeric substance is selected from the group consisting of polyalkylene oxide, polyvinyl alcohol, sodium polyacrylate, methyl cellulose and carboxymethyl cellulose.

7. An ink composition as set forth in claim 3, further comprising a water soluble polymeric substance dissolved in the water.

8. An ink composition as set forth in claim 7, wherein the water soluble polymeric substance is present in an amount of 0.001 to 18 parts by weight per 100 parts by weight of the water.

9. An ink composition as set forth in claim 8, wherein the water soluble polymeric substance is selected from the group consisting of polyalkylene oxide, polyvinyl alcohol, sodium polyacrylate, methyl cellulose and carboxymethyl cellulose.

10. An ink composition as set forth in claim 1, further comprising ethanol in an amount of not more than 100 parts by weight per 100 parts by weight of the water.

11. An ink composition as set forth in claim 4, further comprising ethanol in an amount of not more than 100 parts by weight per 100 parts by weight of the water.

12. An ink composition as set forth in claim 7, further comprising ethanol in an amount of not more than 100 parts by weight per 100 parts by weight of the water.

13. A writing instrument having a pen tip and an ink tank which contains an ink composition according to claim 1 and which is in fluid communication with said pen tip.
